(19) United States
(12) Patent Application Publication
(10) Pub. No.: US 2011/0254851 A1
(43) Pub. Date: Oct. 20, 2011

(54) Imaging Diagnostic Device

(75) Inventor: Rudolf Golser, Hallein (AT)

(73) Assignee: LINKED IP GMBH, Anif (AT)

(21) Appl. No.: 13/084,501

(22) Filed: Apr. 11, 2011

(30) Foreign Application Priority Data
Apr. 14, 2010 (EP) 10003940.3-2201

(51) Int. Cl. G06F 13/14

(52) U.S. Cl. 345/520

(57) ABSTRACT

An imaging diagnostic device including a personal computer, a graphics card, a drive bay that receives an optical drive, an interface that connects the imaging diagnostic device to an examination device, a screen that displays signals received from the examination device as moving images, and a module arranged in the drive bay of the personal computer, said module including a splitter that receives a data stream from the graphics card, a digital signal processor that reduces the data stream and at least one storage unit that records the reduced data stream, the splitter transferring the data stream from the graphics card to the screen and the digital signal processor, the digital signal processor transferring the reduced data stream to the at least one storage unit.

### CROSS-REFERENCE TO RELATED APPLICATIONS

This application claims priority to EP 10003940.3-2201, which was filed on Apr. 14, 2010, the contents of which are hereby incorporated by reference in their entirety.

### FIELD OF THE INVENTION

The invention relates to an imaging diagnostic device and a module for an imaging diagnostic device.

### Related Art

Sonography as an imaging method is, for example, applied in medicine with respect to physical examination, in particular prenatal diagnostics. Moreover, further imaging methods such as endoscopy or radiology are applied by means of such a diagnostic device.

The known imaging diagnostic devices are typically equipped with a PC-based infrastructure, to which a control panel with an integrated keyboard and a screen for the display of the image data obtained are attached and which has an interface for the connection of an examination device such as an ultrasonic probe or a sensor for radiological methods.

By means of complex methods, the examination device converts the signals received by the diagnostic device into moving 2D and/or 3D models, which are finally displayed on the screen as moving images. Since the moving images cannot directly be recorded by the optical drive of the PC for lack of direct access to the actual image data, a digital video recorder, which is generally implemented as external auxiliary equipment, is used in the known diagnostic devices to record and play back the video. Said video recorder is supplied with the image data by means of an additionally required output of the PC-based system, with the image data being typically available as an analog video signal in low resolution only (e.g. S-video, . . . ).

The DVD burner installed in the device is used for the storage of data, whereas this procedure can neither be carried out during the examination for performance reasons regarding the PC-based infrastructure applied.

Due to the external auxiliary device, which is therefore necessary, increased costs incur and additional space is required. Moreover, the external cable connections between the PC and the digital video recorder lead to the usual problems associated with external cables.

### BRIEF SUMMARY OF THE INVENTION

An imaging diagnostic device according to one embodiment includes a personal computer, a graphics card, a drive bay that receives an optical drive, an interface that connects the imaging diagnostic device to an examination device, a screen that displays signals received from the examination device as moving images, and a module arranged in the drive bay of the personal computer, said module including a splitter that receives a data stream from the graphics card, a digital signal processor that reduces the data stream and at least one storage unit that records the reduced data stream, the splitter transferring the data stream from the graphics card to the screen and the digital signal processor, the digital signal processor transferring the reduced data stream to the at least one storage unit.

Another embodiment of the invention is a module for an imaging diagnostic device with a personal computer that includes a graphics card, a drive bay that receives an optical drive, an interface that connects to an examination device, and a screen that displays data received by the examination device as moving images, the module including a splitter, a digital signal processor that reduces the data, and at least one storage unit that records the data, the splitter being connectable to the graphics card of the personal computer, the screen of the personal computer, and the signal processor, the signal processor being connectable to the storage unit, wherein the module is configured to be incorporated into the drive bay.

### BRIEF DESCRIPTION OF THE DRAWINGS

The invention will be further described in reference to the accompanying drawings.

FIG. 1 is a schematic view of a diagnostic device and a module;

FIG. 2 is a perspective view of a printed circuit board of a module; and

FIG. 3 is a perspective view of a module.

### DETAILED DESCRIPTION

The embodiments described herein provide a simply structured diagnostic device with which the moving images received by means of the examination device can be recorded and played back in the imaging diagnostic device based on the high-quality image signal of the system monitor in native resolution and without deterioration of the computing power of the PC-based system.

According to some embodiments of the invention, the existing optical drive including the case in the 5.25″ drive bay of the PC-based system provided for this purpose may be replaced by a module, which is mounted in said drive bay and preferably comprises a case corresponding to the original dimensions of the optical drive of the system. A slim-line drive may be used instead of a standard 5.25″ drive, the additional space gained thereby contains the electronics assembly and the ports required for the module version.

The routing of the image signal to the monitor of the PC-based system by the splitter may be omitted in cases where an additional video output is provided in the device for the recording of the video data and the monitor remains directly connected to the graphics card. Regarding portable and notebook-like devices, this is the case, for example, if the latter comprise an additional output for the connection of an external monitor. For the purpose of recording the moving images, the data volume reduced by the digital signal processor may be supplied to the storage by means of the additional CPU being arranged in the module and/or directly provided as a streaming video via a network connection.

An internal cable connection may be provided in the PC-based system for the connection of the graphics card to the splitter of the module. For this purpose, an analog or digital standard cable may be used, for example a DVI, VGA or S-video cable.

Likewise, the screen of the PC may be connected to the splitter by means of an internal cable connection between the module and the screen, whereas said cable connection, too, may be an analog or digital standard cable, for example a DVI or VGA cable. According to one aspect of the embodiment, the graphics card may not be directly connected to the screen but by means of the splitter using two cables.

A down scaler may be connected to the splitter in the module in order to adapt the input image size to the requirements of the respective video recording method and the parameterization with respect to the image resolution and, if necessary, already reduce thereby the data volume transferred to the digital signal processor. In this respect, it is also possible, in particular, to cut relevant image areas for further processing. That is to say the down scaler typically converts the high resolution of the image signals of the splitter into a lower resolution, for example from SXGA (1280×1024) to D1 format (PAL 720×576 and/or NTSC 720×480).

At the same time, the module according to some embodiments of the invention makes it possible to store and provide the image data in original high resolution. This is of particular importance if innovative data media such as Blue-ray or HD-DVD are used. According to one aspect of the embodiment, a removable non-transitory data medium plugged in the module can also be provided.

By means of the digital signal processor of the module, the video data stream may be encoded using appropriate methods such as MPEG-2, MPEG-4 or H.264, i.e. converted into a compressed video data stream, with the data volume of the video stream being reduced, for example, to 4 or 8 MBit/s.

The video signals compressed by the digital signal processor may be supplied to a CPU, thus a further processor, which is also the central processing unit of the module, hence processes, in particular, the compressed video signals for the recording on the various storage media.

In this respect, said CPU can form part of the digital signal processor or be a component in the module spatially separated from the digital signal processor.

The storage for recording the video signals processed by the CPU can be a volatile or non-volatile storage, for example a SDRAM or flash disk storage. Said storage may either be fixedly arranged inside the module or externally plugged in the module as a removable data medium (example: USB mass storage device). In addition to these storage options, the module may be equipped with an optical data storage system, for example in the form of a DVD or a Blue-ray burner, which is preferably configured as slim-line drive.

Furthermore, the module is preferably furnished with a standard interface such as USB in order to be capable of being connected to the PC-based system.

By means of the USB data cable, commands of the PC-based system, which are, for example, received by the control unit/keyboard or the application software running on the PC-based system, can be transmitted to the module (e.g. record, stop, pause, . . . ). In addition, the PC can access the data stored in the data storages of the module by means of the USB data cable, with the standard optical drive of the PC-based system thus being replaced by the module. Unlike the standard optical drives in the PC-based system, however, the optical drive in the module may be controlled completely autonomously by the locally available processing unit (CPU) of the module.

According to at least one embodiment of the invention, an imaging diagnostic device is thus provided, in which additional external cable connections are omitted due to the module in the drive bay intended for the optical drive of the PC.

According to the invention, the standard examination devices can be connected to the interface of the diagnostic device provided for this purpose, for example an ultrasonic probe for sonography or appropriate sensors for radiological methods such as X-ray procedures, for instance by means of CCDs.

The outward data connection from the module may also be wireless. Optionally, the module can also be used as an external device.

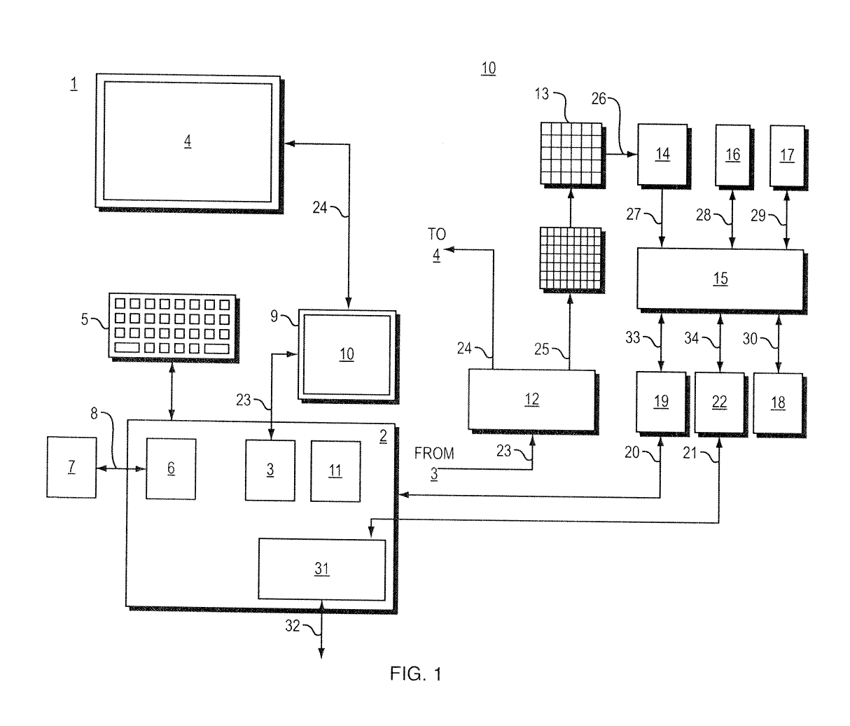

As can be seen from FIG. 1, in particular, the diagnostic device 1 includes a PC-based infrastructure 2 with a graphics card 3 arranged therein, a screen 4 and a keyboard 5. The PC 2 is furnished with an interface 6 for the connection of an examination device 7, e.g. an ultrasonic probe, with a cable 8.

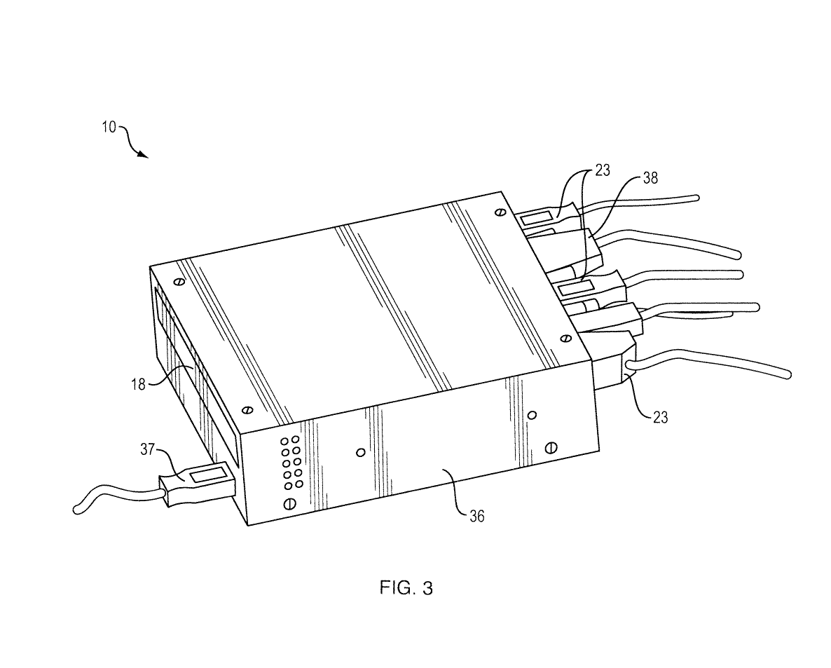

According to one embodiment of the invention, the module 10 may be arranged in the drive bay 9, which is provided in the diagnostic device 1 for receiving an optical drive. As can be seen from FIG. 3, the module 10 may include a case 36, which corresponds to the dimensions of the optical drive of the diagnostic drive 1 at least insofar as it can be incorporated into the drive bay 9.

In addition, the module 10 may include a splitter 12, a down scaler 13, a digital signal processor 14, a CPU 15, a volatile storage 16, a non-volatile storage 17, an optical drive 18 and an interface 19 for the connection of a USB cable marked by the arrow 20 and/or an Ethernet connection (LAN) marked by the interface 22 and the arrow 21. The network card of the diagnostic device 11 and the Ethernet connection of the module 21 may be connected with a HUB or switch 31, which is directly linked to the superordinate network infrastructure/WAN or the Internet via the cable or radio link 32.

The splitter 12 of the module 10 may be connected to the graphics card 3 of the PC-based system 2 by means of an analog or digital standard cable marked by the arrow 23. The data received from the graphics card 3 of the PC-based system 2 may be, on the one hand, transferred by means of the splitter 12 to the screen 4, for example via an analog or digital cable marked by the arrow 24, and, on the other hand, supplied to the down scaler 13 according to the arrow 25. According to the arrow 26, the data stream reduced by the down scaler 13 may be supplied to the digital signal processor 14, which encodes the data stream by appropriate compression methods.

According to the arrow 27, the compressed data stream may be processed by the CPU 15 controlling at the same time all components of the module 10. The video signals are transmitted from the CPU 15 to the volatile storage 16, the non-volatile storage 17 and/or the optical drive 18 according to the arrows 28, 29 and 30. According to the arrows 33 and 34, the video signals stored in the storages 16, 17, 18 can be supplied to the interfaces 19 and/or 22 by means of the CPU 15.

The module 10 may be connected to the PC-based system 2 by means of the USB cable 20. The USB cable 20 is thus an interface for commands of the PC-based system 2 to the module 10, being triggered, for example, by the keyboard 5 of the diagnostic device 1. At the same time, the PC-based system 2 can access data in the storages 16, 17 and/or the data medium in the optical drive 18 of the module 10 by means of the USB cable 20. An external control of the module is also possible via the network connection 32, the HUB/switch 31 and the cable connection 21.

Furthermore, the module 10 may have an input (not shown) for the recording of acoustic signals in the storage 16 or 17 and/or the data medium of the optical drive 18, for example for the recording of sound signals of an ultrasound examination.

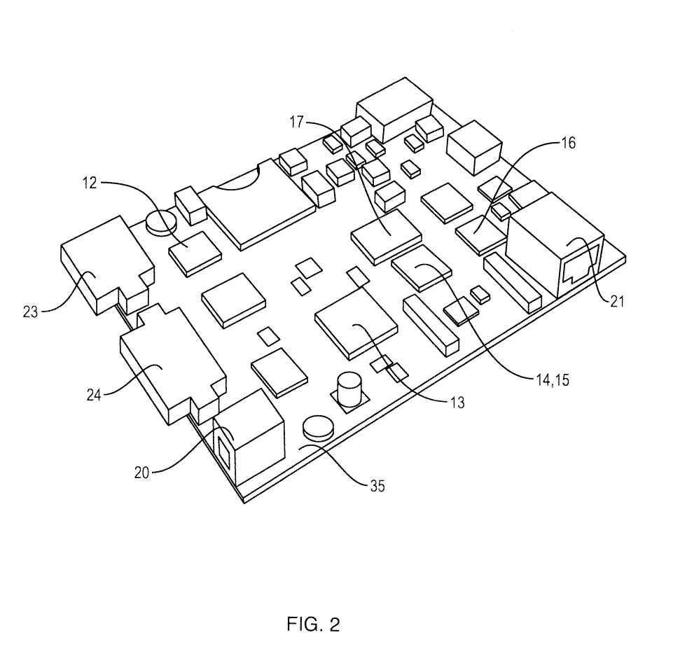

According to FIG. 2, in the case 3 of the module 10 (FIG. 3) a printed circuit board 35 is provided which is populated with the individual components of the module 10, thus the splitter 12, the down scaler 13, the digital signal processor 14 and the CPU as a further processor 15 forming one part with the signal processor 14, the volatile storage 16, the non-volatile storage 17 as well as the ports for the cable connection 20, the network connection 21, the connection 23 of the graphics card 3 with the splitter 12 and the connection 24 of the splitter 2 with the screen 4.

According to FIG. 3, the module may further include a USB connection 37 and an audio connection 38, with the optical drive 18 being configured as a slim-line drive.

What is claimed is:

1. An imaging diagnostic device comprising:
a personal computer,
a graphics card,
a drive bay that receives an optical drive,
an interface that connects the imaging diagnostic device to an examination device,
a screen that displays signals received from the examination device as moving images, and
a module arranged in the drive bay of the personal computer, said module including a splitter that receives a data stream from the graphics card, a digital signal processor that reduces the data stream and at least one storage unit that records the reduced data stream, the splitter transferring the data stream from the graphics card to the screen and to the digital signal processor, the digital signal processor transferring the reduced data stream to the at least one storage unit.

2. The imaging diagnostic device according to claim 1, wherein the module includes a down scaler connected to the splitter that reduces the data stream transferred to the digital signal processor.

3. The imaging diagnostic device according to claim 1, further comprising: a second processor that processes the reduced data stream from the digital signal processor for recording by the storage unit.

4. The imaging diagnostic device according to claim 3, wherein the second processor is a part of the digital signal processor.

5. The imaging diagnostic device according to claim 1, wherein the storage unit is at least one of a volatile storage, a non-volatile storage and a non-transitory data medium.

6. The imaging diagnostic device according to claim 5, wherein the module includes a drive for a non-transitory optical data medium as storage.

7. The imaging diagnostic device according to claim 6, wherein the drive is a slim-line drive.

8. The imaging diagnostic device according to claim 1, wherein the module includes an interface that connects the module to at least one of the personal computer and an Ethernet.

9. The imaging diagnostic device according to claim 8, wherein the interface is configured to connect to at least one of the volatile storage, the non-volatile storage and the optical drive.

10. The imaging diagnostic device according to claim 1, wherein the interface connects to the personal computer via a serial bus system.

11. The imaging diagnostic device according to claim 1, wherein the module includes an input that receives acoustic signals for storage in the storage unit.

12. The imaging diagnostic device according to claim 1, wherein the module predefines, for the personal computer via an interface, whether the module is a universal serial bus mass storage device or a native digital versatile disk drive, enabling the personal computer to boot via a digital versatile disk inserted into the module.

13. The imaging diagnostic device according to claim 1, wherein the data stream received by the module is transferable online via a network.

14. A module for an imaging diagnostic device with a personal computer that includes a graphics card, a drive bay that receives an optical drive, an interface that connects to an examination device, and a screen that displays data received by the examination device as moving images, the module comprising:
a splitter,
a digital signal processor that reduces the data, and
at least one storage unit that records the data, the splitter being connectable to the graphics card of the personal computer, the screen of the personal computer, and the signal processor, the signal processor being connectable to the storage unit,
wherein the module is configured to be incorporated into the drive bay.
